(19) United States
(12) Patent Application Publication
(10) Pub. No.: US 2007/0221616 A1
(43) Pub. Date: Sep. 27, 2007

(54) Etching method

(76) Inventors: Yi-Tyng Wu, Chiayi City (TW); Hua-Wei Yu, Toufen Township (TW)

Correspondence Address: J.C. Patents, Inc., Suite 250, 4 Venture, Irvine, CA, 92618, US

(21) Appl. No.: 11/388,491

(22) Filed: Mar. 24, 2006

(51) Int. Cl. C03C 25/68; B44C 1/22

(52) U.S. Cl. 216/58; 216/63; 216/67; 216/70

(57) ABSTRACT

The invention is directed to a method for etching a color filter. The method comprises steps of providing a substrate having a multilayered filter material layer formed thereon and then disposing the substrate into an etching chamber with introducing a gas mixture into the etching chamber for performing a dry etching process so as to pattern the multilayered filter material layer, wherein the gas mixture comprises a physical reactive gas and a chemical reactive gas.

### BACKGROUND OF THE INVENTION

1. Field of Invention

The present invention relates to a method for forming a optical device. More particularly, the present invention relates to a method for etching a color filter.

2. Description of Related Art

Currently, the multimedia technology is well developed and is benefited from the improvement of the semiconductor device or the display device. As for the display, the liquid crystal display having superior features, such as high definition, good space utilization efficiency, low power consumption and no radiation, becomes the mainstream of the market.

Liquid crystal display mainly comprised of a display panel and a back light module, wherein the display panel comprises an active array display substrate and a color filter. The color filter is used to filter the light transmitted from the back light module so as to make the liquid crystal display has the true color functionality.

The color filter can be a single film layered filter or a filter possessing complex layered structure. Generally, the filter possessing complex layered structure is formed by interlacing and stacking several film layers which have different refraction indices from each other so that the filter can filter off certain wavelength. In the process for forming the filter possessing complex layered structure, the film layers with different refraction indices are formed on the substrate sequentially and then the film layers are patterned by using sputtering etching process.

Usually, the etching gas used in the conventional sputtering etching process is the gas mixture comprised of chlorofluorocarbon, fluorocarbon and chlorine gas.

However, the thickness of the common filter is larger than 8000 angstrom (800 nm). When the aforementioned etching gas is used to perform the etching process, the etching rate is about 17˜22 nm/min which is so slow that the time for performing the etching process is too long and the conventional etching rate is not even close to the etching rate, which is required to be 300 nm/min, for the mass production. Hence, the conventional etching process cannot effectively mass produce filters.

### SUMMARY OF THE INVENTION

Accordingly, at least one objective of the present invention is to provide a method for etching color filter capable of effectively increase the etching rate.

At least another objective of the present invention is to provide a method for etching color filter capable of effectively decreasing etching time.

At least the other objective of the present invention is to provide a method for forming a color filter capable of effectively decreasing the time for forming the color filter.

To achieve these and other advantages and in accordance with the purpose of the invention, as embodied and broadly described herein, the invention provides a method for etching a color filter. The method comprises steps of providing a substrate having a multilayered filter material layer formed thereon and then disposing the substrate into an etching chamber with introducing a gas mixture into the etching chamber for performing a dry etching process so as to pattern the multilayered filter material layer, wherein the gas mixture comprises a physical reactive gas and a chemical reactive gas.

According to the aforementioned method of one embodiment of the present invention, the chemical reactive gas comprises a first gas and a second gas, and the first gas includes a fluorinated hydrocarbon gas and the second gas includes a fluorine-containing inorganic gas.

According to the aforementioned method of one embodiment of the present invention, the fluorine-containing inorganic gas is selected from a group consisting of sulfur hexafluoride, nitrogen fluoride and the combination thereof.

According to the aforementioned method of one embodiment of the present invention, the fluorinated hydrocarbon gas comprises perfluorocarbons.

According to the aforementioned method of one embodiment of the present invention, the first gas further comprises chlorine gas.

According to the aforementioned method of one embodiment of the present invention, the physical reactive gas is selected from a group consisting of argon, boron trichloride and the combination thereof.

According to the aforementioned method of one embodiment of the present invention, the etching chamber comprises a reactive ion etching chamber, a transformer coupled plasma chamber, an electron cyclotron resonance chamber and a magnetic enhanced reactive ion etching chamber.

The present invention also provides a method for etching a color filter. The method comprises steps of providing a substrate having a multilayered filter material layer formed thereon and disposing the substrate into an etching chamber with introducing a gas mixture into the etching chamber for performing a dry etching process so as to pattern the multilayered filter material layer, wherein the gas mixture a first gas and a second gas, and the first gas comprises a fluorinated hydrocarbon gas and the second gas comprises a fluorine-containing inorganic gas including sulfur hexafluoride, nitrogen fluoride or the combination of sulfur hexafluoride and nitrogen fluoride.

According to the aforementioned method of one embodiment of the present invention, the flow rate of the fluorinated hydrocarbon gas is about 1˜5 times of that of sulfur hexafluoride.

According to the aforementioned method of one embodiment of the present invention, the fluorinated hydrocarbon comprises perfluorocarbons.

According to the aforementioned method of one embodiment of the present invention, the flow rate of perfluorocarbons is about 2˜10 times of that of sulfur hexafluoride.

According to the aforementioned method of one embodiment of the present invention, the first gas further comprises chlorine gas.

According to the aforementioned method of one embodiment of the present invention, the gas mixture further comprises argon, boron trichloride and the combination thereof.

According to the aforementioned method of one embodiment of the present invention, the flow rate of argon is about 5˜50 times of that of sulfur hexafluoride.

According to the aforementioned method of one embodiment of the present invention, the flow rate of boron trichloride is about 0.5˜10 times of that of sulfur hexafluoride.

The present invention further provides a method for manufacturing a color filter. The method comprises steps of providing a substrate and forming a first complex layer on the substrate. A pattern process is performed on the first complex layer to form a first filter. A second complex layer is formed over the substrate and the pattern process is performed on the second complex layer to form a second filter. A third complex layer is formed over the substrate and the pattern process is performed on the third complex layer to form a third filter, wherein the pattern process comprises disposing the substrate into an etching chamber with introducing a gas mixture into the etching chamber for performing a dry etching process and the gas mixture comprises a physical reactive gas and a chemical reactive gas.

According to the aforementioned method of one embodiment of the present invention, the chemical reactive gas comprises a first gas and a second gas and the first gas comprises a fluorinated hydrocarbon gas and the second gas comprises a fluorine-containing inorganic gas.

According to the aforementioned method of one embodiment of the present invention, the fluorine-containing inorganic gas is selected from a group consisting of sulfur hexafluoride, nitrogen fluoride and the combination thereof.

According to the aforementioned method of one embodiment of the present invention, the fluorinated hydrocarbon comprises perfluorocarbons.

According to the aforementioned method of one embodiment of the present invention, the first gas further comprises chlorine gas.

According to the aforementioned method of one embodiment of the present invention, the physical reactive gas is selected from a group consisting of argon, boron trichloride or the combination thereof.

According to the aforementioned method of one embodiment of the present invention, the etching chamber comprises a reactive ion etching chamber, a transformer coupled plasma chamber, an electron cyclotron resonance chamber and a magnetic enhanced reactive ion etching chamber.

According to the aforementioned method of one embodiment of the present invention, the first complex layer comprises a red film layer.

According to the aforementioned method of one embodiment of the present invention, the second complex layer comprises a green film layer.

According to the aforementioned method of one embodiment of the present invention, the third complex layer comprises a blue film layer.

In the present invention, the fluorine-containing inorganic gas such as sulfur hexafluoride, nitrogen fluoride and the combination of sulfur hexafluoride and nitrogen fluoride is used as the chemical reactive gas in the etching process so that enough fluorine ions are provided for performing the reaction in the etching process to achieve the goal for increasing the etching rate of the etching process. Furthermore, the etching method of the present invention can be applied to the method for forming a color filter so that the time for producing the color filter can be decreased and the yield is increased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing an etching method according one embodiment of the present invention.

FIGS. 2A through 2F are cross-sectional views showing a method for forming a color filter according to one embodiment of the present invention.

### DESCRIPTION OF THE PREFERRED EMBODIMENTS

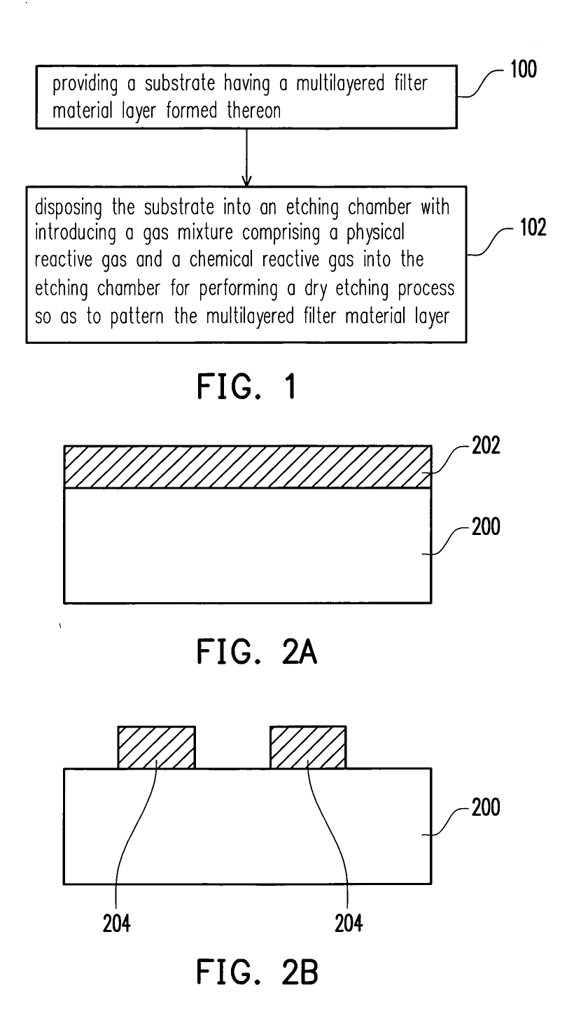

FIG. 1 is a flow chart showing an etching method according one embodiment of the present invention. As shown in FIG. 1, in the step 100, a substrate having a multilayered filter material layer and the well known semiconductor devices formed thereon is provided. The multilayered filter material layer can be, for example but not limited to, composed of several film layers which are interlacing and stacking to each other and possess different refraction indices from each other. The thickness of the multilayered filter material layer is about 8000 angstroms. For example, the multilayered filter material layer can be formed by stacking the film layers on the substrate in an order from the film layer with a relatively lower refraction index to the film layer with a relatively higher refraction index from the bottom to the top of the multilayered filter material layer. Alternatively, in another embodiment, the multilayered filter material layer can be, for example, formed by stacking the film layers on the substrate in an order from the film layer with a relatively higher refraction index to the film layer with a relatively lower refraction index from the bottom to the top of the multilayered filter material layer. Moreover, the multilayered filter material layer in the present invention can be, for example, a infrared filter, a ultraviolet filter, an RGB color filter or a CYM color filter.

Thereafter, in the step 102, the substrate is disposed into an etching chamber with introducing a gas mixture comprising a physical reactive gas and a chemical reactive gas for performing a dry etching process so as to pattern the multilayered filter material layer. The etching chamber can be, for example but not limited to, a reactive ion etching chamber, a transformer coupled plasma chamber, an electron cyclotron resonance chamber or a magnetic enhanced reactive ion etching chamber. Furthermore, the physical reactive gas can be, for example, argon, boron trichloride or the combination of the argon and boron trichloride for providing a resource for the ion bombardment. The chemical reactive gas can be, for example, comprises a first gas and a second gas. The first gas can be, for example, a fluorinated hydrocarbon gas such as perfluorocarbons. Additionally, the first gas further comprises chlorine gas. The second gas can be, for example, a fluorine-containing gas such as sulfur hexafluoride, nitrogen fluoride and the combination of sulfur hexafluoride and nitrogen fluoride for providing enough fluorine ions to perform the reaction during the etching process so as to increase the etching rate.

In one embodiment, the first gas can be, for example, perfluorocarbons and the second gas can be, for example, sulfur hexafluoride, and the flow rate of perfluorocarbons is about 2˜20 times of that of sulfur hexafluoride. Moreover, if the first gas is fluorinated hydrocarbon gas, such as fluorinated alkane, fluorinated alkene and fluorinated alkyne, the flow rate of the fluorinated hydrocarbon gas is about 1˜10 times of that of sulfur hexafluoride. Furthermore, the flow rage of argon is about 5˜50 times of that of sulfur hexafluoride. Alternatively, the flow rate of boron trichloride is about 0.5˜10 times of that of sulfur hexachloride. It should be noticed that, as the aforementioned gas is the etching gas in the etching process, the etching rate can be improved from the conventional 17˜22 nm/min to 500 nm/min so as to achieve the goal for mass producing filters.

Noticeably, the etching method of the present invention can be applied to the method for forming a color filter so that the time for producing the color filter can be decreased and the yield is increased.

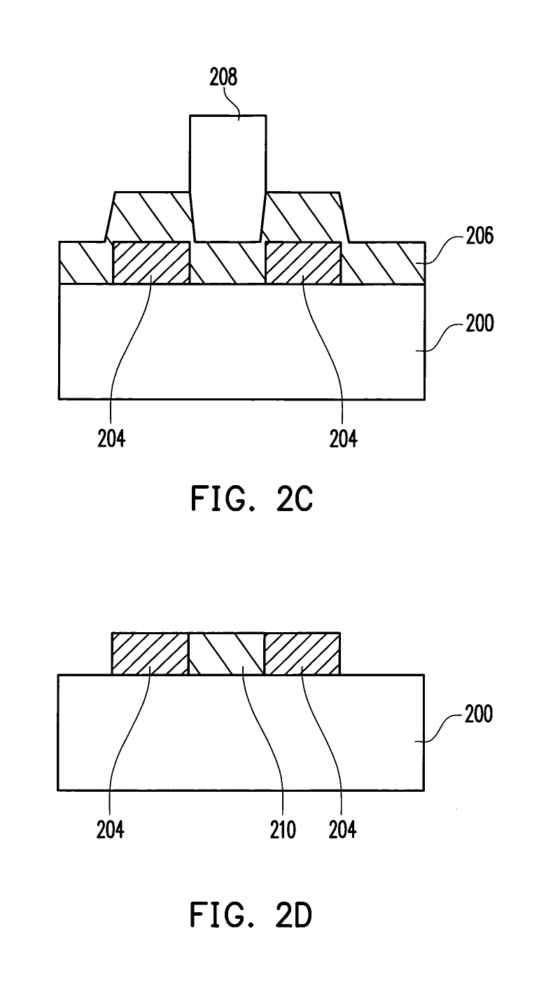

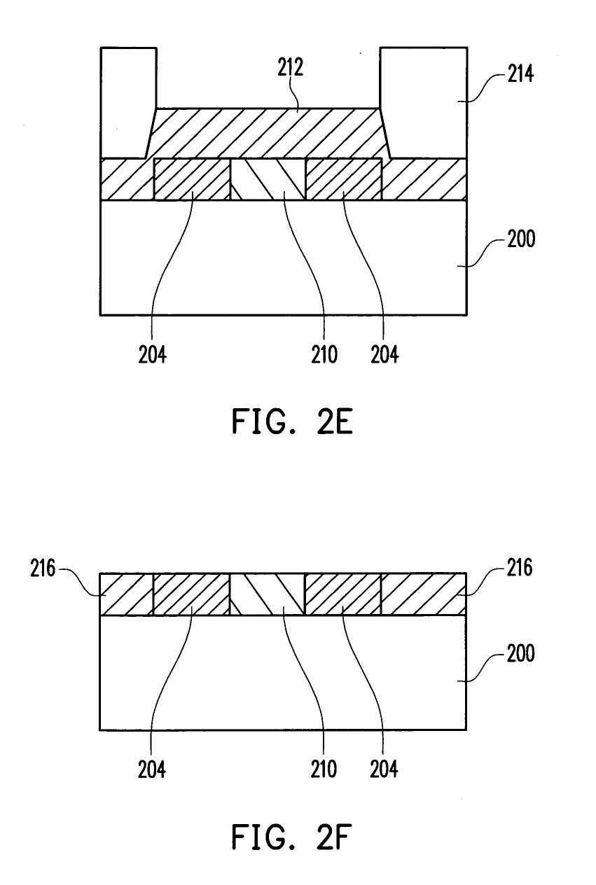

FIGS. 2A through 2E are cross-sectional views showing a method for forming a color filter according to one embodiment of the present invention. First, a substrate 200 is provided. The substrate 200 can be, for example, a silicon substrate and the substrate 200 has well known semiconductor devices (not shown) formed thereon. Then, a complex layer 202 is formed on the substrate 200. The complex layer 202 can be, for example, a red film layer formed by performing a physical vapor deposition or a chemical vapor deposition to form several film layers which are interlacing and stacking to each other but possess different refraction indices from each other. For example, the complex layer 202 can be, for example, formed by stacking the film layers on the substrate 200 in an order from the film layer with a relatively lower refraction index to the film layer with a relatively higher refraction index. Alternatively, in another embodiment, the complex layer 202 can be, for example, formed by stacking the film layers on the substrate 200 in an order from the film layer with a relatively higher refraction index to the film layer with a relatively lower refraction index.

As shown in FIG. 2B, a pattern process is performed on the complex layer 202 so as to transform the complex layer 202 to be a filter 204. The pattern process comprises steps of forming a patterned photoresist layer (not shown) on the complex layer 202 and then disposing the substrate 200 into an etching chamber with introducing a gas mixture containing a physical reactive gas and a chemical reactive gas into the etching chamber for performing a dry etching process to pattern the complex layer 202 by using the patterned photoresist layer as a mask. The physical reactive gas can be, for example, argon, boron trichloride or the combination of argon and boron trichloride for providing a resource for the ion bombardment. The chemical reactive gas can be, for example, comprises a first gas and a second gas. The first gas can be, for example, a fluorinated hydrocarbon gas such as perfluorocarbons. Additionally, the first gas further comprises chlorine gas. The second gas can be, for example, a fluorine-containing gas such as sulfur hexafluoride, nitrogen fluoride and the combination of sulfur hexafluoride and nitrogen fluoride for providing enough fluorine ions to perform the reaction during the etching process so as to increase the etching rate. The etching chamber can be, for example but not limited to, a reactive ion etching chamber, a transformer coupled plasma chamber, an electron cyclotron resonance chamber or a magnetic enhanced reactive ion etching chamber. Then, the patterned photoreisit layer is removed.

As shown in FIG. 2C, a complex layer 206 is formed on the substrate 200. The complex layer 206 can be, for example, a green film layer which is formed by using the method as same as the method used to form the complex layer 202 and the method is not described herein. Then, a patterned photoresist layer 208 is formed on the complex layer 206 to cover a portion of the complex layer 206 pre-determined to form the green filter.

As shown in FIG. 2D, the aforementioned dry etching process is performed on the complex layer 206 to transform the complex layer 206 into a filter 210. Thereafter, the patterned photoresist layer 208 is removed.

Then, as shown in FIG. 2E, a complex layer 212 is formed on the substrate 200. The complex layer 212 can be, for example, a blue film layer which is formed by using the method as same as the method used to form the complex layer 202 and the method is not described herein. Then, a patterned photoresist layer 214 is formed on the complex layer 212 to cover a portion of the complex layer 212 pre-determined to form the blue filter.

As shown in FIG. 2F, the aforementioned dry etching process is performed on the complex layer 212 to convert the complex layer 212 into a filter 216. Then, the patterned photoresist layer 214 is removed.

Noticeably, the order for forming the red filter, the green filter and the blue filter is not limited to the description mentioned in the above embodiment and can be alternatively adjusted according to the requirement.

Altogether, in the present invention, the fluorine-containing inorganic gas which is comprised of sulfur hexafluoride, nitrogen fluoride and the combination of sulfur hexafluoride and nitrogen fluoride as the chemical reactive gas in the etching process so that enough fluorine ions can be provided to perform the reaction in the etching process. Therefore, the etching rate is increased and the process time is decreased. Moreover, the etching method of the present invention can be applied to the method for forming a color filter so that the time for producing the color filter can be decreased and the yield is increased.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for etching a color filter, comprising:
providing a substrate having a multilayered filter material layer formed thereon; and
disposing the substrate into an etching chamber with introducing a gas mixture into the etching chamber for performing a dry etching process so as to pattern the multilayered filter material layer, wherein the gas mixture comprises a physical reactive gas and a chemical reactive gas.

2. The method of claim 1, wherein the chemical reactive gas comprises a first gas and a second gas, and the first gas includes a fluorinated hydrocarbon gas and the second gas includes a fluorine-containing inorganic gas.

3. The method of claim 2, wherein the fluorine-containing inorganic gas is selected from a group consisting of sulfur hexafluoride, nitrogen fluoride and the combination thereof.

4. The method of claim 2, wherein the fluorinated hydrocarbon gas comprises perfluorocarbons.

5. The method of claim 4, wherein the first gas further comprises chlorine gas.

6. The method of claim 1, wherein the physical reactive gas is selected from a group consisting of argon, boron trichloride and the combination thereof.

7. The method of claim 1, wherein the etching chamber comprises a reactive ion etching chamber, a transformer coupled plasma chamber, an electron cyclotron resonance chamber and a magnetic enhanced reactive ion etching chamber.

8. A method for etching a color filter, comprising:
providing a substrate having a multilayered filter material layer formed thereon; and
disposing the substrate into an etching chamber with introducing a gas mixture into the etching chamber for performing a dry etching process so as to pattern the multilayered filter material layer, wherein the gas mixture a first gas and a second gas, and the first gas comprises a fluorinated hydrocarbon gas and the second gas comprises a fluorine-containing inorganic gas including sulfur hexafluoride, nitrogen fluoride or the combination of sulfur hexafluoride and nitrogen fluoride.

9. The method of claim 8, wherein the flow rate of the fluorinated hydrocarbon gas is about 1˜5 times of that of sulfur hexafluoride.

10. The method of claim 8, wherein the fluorinated hydrocarbon comprises perfluorocarbons.

11. The method of claim 10, wherein the flow rate of perfluorocarbons is about 2˜10 times of that of sulfur hexafluoride.

12. The method of claim 10, wherein the first gas further comprises chlorine gas.

13. The method of claim 8, wherein the gas mixture further comprises argon, boron trichloride and the combination thereof.

14. The method of claim 13, wherein the flow rate of argon is about 5˜50 times of that of sulfur hexafluoride.

15. The method of claim 13, wherein the flow rate of boron trichloride is about 0.5˜10 times of that of sulfur hexafluoride.

16. A method for manufacturing a color filter, comprising:
providing a substrate;
forming a first complex layer on the substrate;
performing a pattern process on the first complex layer to form a first filter;
forming a second complex layer over the substrate;
performing the pattern process on the second complex layer to form a second filter;
forming a third complex layer over the substrate; and
performing the pattern process on the third complex layer to form a third filter, wherein the pattern process comprises disposing the substrate into an etching chamber with introducing a gas mixture into the etching chamber for performing a dry etching process and the gas mixture comprises a physical reactive gas and a chemical reactive gas.

17. The method of claim 16, wherein the chemical reactive gas comprises a first gas and a second gas and the first gas comprises a fluorinated hydrocarbon gas and the second gas comprises a fluorine-containing inorganic gas.

18. The method of claim 17, wherein the fluorine-containing inorganic gas is selected from a group consisting of sulfur hexafluoride, nitrogen fluoride and the combination thereof.

19. The method of claim 17, wherein the fluorinated hydrocarbon comprises perfluorocarbons.

20. The method of claim 16, wherein the first gas further comprises chlorine gas.

21. The method of claim 16, wherein the physical reactive gas is selected from a group consisting of argon, boron trichloride or the combination thereof.

22. The method of claim 16, wherein the etching chamber comprises a reactive ion etching chamber, a transformer coupled plasma chamber, an electron cyclotron resonance chamber and a magnetic enhanced reactive ion etching chamber.

23. The method of claim 16, wherein the first complex layer comprises a red film layer.

24. The method of claim 16, wherein the second complex layer comprises a green film layer.

25. The method of claim 16, wherein the third complex layer comprises a blue film layer.
